(19) United States
(12) Patent Application Publication
(10) Pub. No.: US 2004/0138364 A1
(43) Pub. Date: Jul. 15, 2004

(54) Enamelling composition and method for producing a part formed from enamelled sheet metal

(76) Inventors: Jean Schrynemackers, Chaudfontaine (BE); Christophe Abeloos, Liege (BE)

Correspondence Address: BROWDY AND NEIMARK, P.L.L.C., 624 NINTH STREET, NW, SUITE 300, WASHINGTON, DC, 20001-5303, US

(21) Appl. No.: 10/471,864

(22) PCT Filed: Mar. 12, 2002
(86) PCT No.: PCT/BE02/00032

(30) Foreign Application Priority Data
Mar. 13, 2001 (EP) 01870043.5

(51) Int. Cl. C08K 3/34; C08K 3/18

(52) U.S. Cl. 524/430; 524/492; 524/275

(57) ABSTRACT

The invention relates to a solvent-free powder enamelling composition comprising an enamel frit and a thermosetting resin. In order to produce a part formed from enamelled sheet metal, a layer of said enamelling composition is applied to at least one face of a piece of flat sheet metal. Said layer is then heated in order to cross-link the thermosetting resin. Subsequently, the sheet which is coated with the cross-linked composition is then formed and baked, first to pyrolyse the organic matter in the composition and then to vitrify the enamel frit.

The invention relates to an enamelling composition and a method of producing a piece formed from enamelled sheet.

The traditional method of producing a piece formed from enamelled sheet comprises principally the following operations:

a piece of flat sheet is formed (by drawing, and/or folding and/or bending, etc.);

the formed sheet is degreased and pickled and possibly subjected to other surface treatments such as phosphatising, nickel plating, etc.);

a layer of powdery enamel frit is applied to the piece of sheet thus prepared (for example by means of an electrostatic gun);

the piece thus coated is cured in order to cause the vitrification of the enamel frit.

Such a traditional method has certain drawbacks. It should be noted first of all that this method necessarily necessitates a pre-treatment (degreasing, pickling, phosphatising, etc.) of the formed pieces of sheet, at the premises of the enameller. However, whereas the pre-treatment of flat sheets is a relatively simple and quick operation, which can be performed in a continuous operation, the pre-treatment of formed pieces of sheet is substantially more complicated and slower.

Moreover, whereas with current techniques the application of an enamelling composition to flat sheets can be performed quickly, in a continuous operation and very consistently (hence an excellent consistency of thickness of the layer of enamel), the application of an enamelling composition to formed pieces of sheet is an operation which is inevitably slower and more complex and which does not allow the same consistency of thickness of the layer of enamel to be obtained.

An attempt has already been made to remedy these drawbacks of the traditional enamelling technique.

The document U.S. Pat. No. 5,325,580 describes a method of producing pieces formed from enamelled sheet, in which:

before the forming, a layer of a composition comprising an enamel frit dispersed in a solution of a polymer binder is applied (with a roller) to a steel sheet, and then this layer is dried (evaporation of solvent) and/or cured;

possibly, a second layer of such a composition is applied, which is, in its turn, dried and/or cured;

this coated sheet is then formed, in the form of the piece to be produced;

the coated and formed piece of sheet is then cured, at a temperature between 560° C. and 850° C., so as to burn the polymer binder and vitrify the enamel frit.

The technique described in U.S. Pat. No. 5,325,580 offers certain advantages compared with the earlier known enamelling technique. In particular, this new technique makes it possible to apply the enamelling composition to flat sheets and no longer to preformed sheets.

The flat sheets thus coated can be supplied to the enameller; the sheets no longer have to be pre-treated in the works of said enameller.

The technique according to U.S. Pat. No. 5,325,580 however necessitates that, following the application of the fluid enamelling composition to the flat sheets, large quantities of solvent must be evaporated and incinerated. The polymer binders contained in the enamelling compositions described in this document can be thermoplastic polymers or thermosetting resins. Coatings obtained with the compositions containing thermoplastic polymers (before the vitrification curing) are not very stable (in particular, they do not withstand solvents well). The preference is therefore for compositions containing thermosetting resins which make it possible to obtain coatings which are more stable and also withstand the forming operation better. However, the fluid enamelling composition based on thermosetting resin which is specifically described in U.S. Pat. No. 5,325,580 lacks stability at ambient temperature, the constituents of the thermosetting resin dissolved in the composition having a tendency to react with one another, even at ambient temperature, which gives rise to a change in viscosity which requires frequent adaptations of the application conditions, in particular in the case of coating by roller.

The aim of the present invention is consequently to propose an enamelling technique which does not have these drawbacks of the earlier technique.

The object of the present invention is an enamelling composition comprising an enamel frit and a thermosetting resin, this composition consisting of a powder in the form of a substance which contains no solvent for this resin.

In the definition of the composition given above, it must be understood that the thermosetting resin or the constituents from which it is made can obviously not be considered as “solvents”.

The composition according to the invention in principle contains no solvent. The expression “in the form of a substance which contains no solvent” is used here in order to take account of the fact that the composition could nevertheless have a very low solvent content, which could be due, for example, to the fact that solvent is contained in small quantity or to there being traces in the thermosetting resin or in one or other of its constituents.

According to an advantageous embodiment, the said thermosetting resin comprises:

one or more cross-linkable polymers,

one or more cross-linking agents able to cause the cross-linking of the cross-linkable polymer or polymers, in sufficient quantity to cross-link the cross-linkable polymer or polymers,

at least one catalyst, in sufficient quantity to catalyse the cross-linking reaction between the cross-linkable polymer or polymers and the cross-linking agent or agents.

The thermosetting resins contained in the composition can in particular be chosen from amongst the thermosetting resins which are conventionally used in powder paint compositions.

The cross-linkable polymers included in these resins can in particular be chosen from amongst the cross-linkable polymers of the epoxy, polyester or acrylic type.

The cross-linking agent (or “hardening agent”) which has to cause cross-linking by reacting with the reactive groups of the cross-linkable polymer must obviously be chosen, in a known manner, according to the polymer to be cross-linked, and more particularly according to the nature of the reactive groups of this polymer. The ratio between the cross-linkable polymer and the cross-linking agent must also be chosen, in a known manner, according to the nature of these substances used and according to the desired level of cross-linking.

The catalyst or catalysts which form part of the composition must obviously also be chosen according to the cross-linkable polymer and the cross-linking agent included in the composition, since they must catalyse the reaction between these substances.

The cross-linkable polymer or polymers, the cross-linking agent or agents and the catalyst or catalysts, as well as the ratio between these constituents, must be chosen so that the cross-linking reaction is only very small during the manufacture of the composition (which will be described below), but so that this cross-linking is fast and sufficient at the time it is wished to cause it, during the use of the composition.

The thermosetting resin can advantageously also comprise at least one spreading agent. The spreading agents, which contribute towards obtaining good spreading and a good appearance of the fused film which will be formed on the sheet, can in particular be chosen from amongst the spreading agents known in the powder paint field. These spreading agents can in particular be polyacrylate-based.

The thermosetting resin can advantageously also comprise at least one degassing agent able to carry away the volatile products formed during the cross-linking operation. The degassing agent, which makes it possible to avoid the formation of defects, such as “pin holes”, can in particular be chosen from amongst the degassing agents known in the powder paint field, and can for example consist of benzoin.

According to a particular embodiment of the invention, the composition also comprises at least one lubricating agent. The lubricating agent can in particular be chosen from amongst polyethylene waxes, oxidised polyethylene waxes, and low molecular weight copolymers of ethylene with vinyl acetate or acrylic acid. The incorporation of a small quantity (for example of the order of 1% by weight) of such a lubricating agent in the composition facilitates the forming of a sheet coated with a cross-linked film obtained starting from the composition according to the invention. The presence of such a lubricant in the composition can above all be useful for reducing the risk of degradation of such a cross-linked film, when the forming of the sheet requires large deformations (for example during forming by deep drawing).

Advantageously, the composition according to the invention contains at least 50%, and preferably at least 70%, by weight enamel frit, compared with the total weight of the composition.

As an enamel frit included in the composition, use can be made of one or other of the enamel frits usually used for enamelling on steel sheet when the application of the enamel is carried out after the forming of the bare sheets.

It must be noted that, for enamelling of sheets by the conventional method, a first type of enamel frit is generally used to form the base enamel referred to as the “ground-coat enamel”, intended to form the first adherent layer applied in contact with the metal. A second type of enamel frit is then used to form the final layer of enamel (or “cover-coat enamel”) which is generally opaque, white or coloured. One or other of these types of enamel frit can be used to manufacture a composition in accordance with the invention, according to whether this composition is intended to be used to form the first or the second layer of enamel.

The tables below indicate, as examples, common frit compositions:

| | |
|---|---|
| - for the base enamel, | - for the white enamel, |
| intended for the | intended for the |
| first adherent layer | surface layer, applied |
| applied in contact | before or after |
| with the metal: | forming: |

| frit | weight % | frit | weight % |
|---|---|---|---|
| SiO2 | 40-60 | SiO2 | 30-50 |
| Al2O3 | 0-7 | Al2O3 | 0-5 |
| B2O3 | 10-20 | B2O3 | 12-24 |
| K2O | 0-8 | K2O | 1-10 |
| CaO | 0-10 | Na2O | 5-15 |
| Na2O | 5-20 | Li2O | 0-4 |
| Li2O | 0-10 | TiO2 | 0-25 |
| BaO | 0-20 | ZnO | 0-3 |
| ZrO2 | 0-10 | MgO | 0-3 |
| CoO | 0.5-2.5 | CaO | — |
| MnO | 0-4 | P2O5 | 0-5 |
| CuO | 0-4 | F2 | 0-5 |
| NiO | 1-5 | | |
| P2O5 | 0-5 | | |
| F2 | 0-7 | | |
| TiO2 | 0-5 | | |

The enamel frit included in the composition preferably has a particle size distribution such that less than 10% by volume (for example between 6% and 10%) has failed to pass after sieving with a 40 μm sieve (in accordance with EN 10209).

The composition according to the invention, as a whole, must consist of a fine powder, the maximum of its particle size distribution curve measured on an apparatus of the Coulter® type being advantageously equal to or less than 100 μm, and preferably equal to or less than 80 μm.

Another object of the invention is a method of manufacturing an enamelling composition as described above, a method according to which:

enamel frit in powder form and thermosetting resin in powder or granular form are mixed,

this mixture is heated and plasticated at a temperature higher than the fusion temperature of the thermosetting resin but lower than the cross-linking temperature,

the mixture thus plasticated hot is then cooled below the glass transition temperature of the thermosetting resin, and

the mixture thus cooled and solidified is then converted into powder.

The aim of the hot plastication of the constituents of the composition is to obtain a fine and consistent dispersion of the enamel frit in the resin, a dispersion in which the grains of enamel powder are coated in the resin.

The plastication of the mixture must be carried out at a temperature at which the thermosetting resin is sufficiently fluidised to obtain a good dispersion of the enamel frit in this resin, but at which there is no or very little cross-linking. For certain compositions, this plastication will be carried out for example at a temperature of 130° to 140° if the cross-linking reaction takes place, significantly, only above 180° C.

Heating and plastication of the mixture at a temperature higher than the fusion temperature of the thermosetting resin can advantageously be carried out in a heated extruder.

According to a particular embodiment, the mixture heated and plasticated at a temperature higher than the fusion temperature of the thermosetting resin is rolled between cooled cylinders, the cooled sheeting thus obtained then being converted into powder by crushing and grinding.

Another object of the present invention is a method of fabricating a sheet coated with a composition containing an enamel frit and a thermosetting resin. According to this method, a layer of a powdery enamelling composition as described above is applied to at least one of the two faces of a sheet, this layer then being heated at a temperature and for a length of time making it possible to cross-link the thermosetting resin contained in the composition.

Under the effect of this heating, the layer of powdery composition fluidises and is converted into a continuous film, the continuation of the heating causing the cross-linking of the resin contained in the composition.

After having applied a layer of the said powdery composition to at least one of the two faces of the sheet and after having caused the cross-linking of the thermosetting resin in this layer, a further layer of powdery composition according to the invention can possibly be applied to at least one of the two faces of the said sheet, this further layer then being heated at a temperature and for a length of time making it possible to cross-link the thermosetting resin of this further layer.

It should be understand that this method can be implemented according to many variants. According to one of these variants, there is first applied to the two faces of a bare sheet a layer of a powdery enamelling composition in accordance with the invention, containing “ground-coat” enamel frit, this layer then being heated in order to cause cross-linking. There is then applied to one of the two faces of the sheet a further layer of powdery composition according to the invention, containing “cover-coat” enamel frit, this layer then being heated in order to cause its cross-linking.

The layer or layers of powdery composition are preferably deposited on the sheet by electrostatic application.

For applying this powdery composition in a continuous operation to strips of sheet, conventional powder application techniques, such as electrostatic spraying with a gun, can possibly be used.

But, according to a preferred variant of the invention, a method typically developed for the application of powder in a continuous operation, such as one of the methods described in the documents U.S. Pat. No. 4,795,339, U.S. Pat. No. 5,279,863 or BE 9800367, will be used.

Before the application of a first layer of the powdery composition according to the invention to a sheet, this sheet must be degreased.

Before the application of the layer of powdery composition, the degreased sheet can possibly also be subjected to one or more surface treatments, such as pickling, passivation, nickel plating, etc.

As a general rule, it is advantageous but also sufficient to subject the degreased sheet to phosphatising treatment, for example amorphous phosphatising using iron.

The heating of a layer of the said powdery composition applied to a sheet, in order to cross-link the thermosetting resin in this layer, can be obtained by causing this sheet to pass through one or more hot-air ovens.

According to an advantageous embodiment, this heating can however be obtained by causing the said sheet to pass through one or more induction ovens.

Another object of the invention is a method of producing a piece formed from enamelled sheet. According to this method,

there is fabricated according to the method described above, (or one of the variants of this method), a sheet coated with a composition (cross-linked) containing an enamel frit and a thermosetting resin,

the sheet coated with the said cross-linked composition is formed in the form of the said piece to be produced,

the piece formed is cured under conditions adapted to obtain complete pyrolysis of the cross-linked polymer, the temperature being maintained below the vitrification temperature of the frit contained in the composition, during this pyrolysis curing,

the curing of the piece is then continued by increasing the temperature up to an appropriate temperature in order to obtain vitrification of the enamel, and

the enamelled formed piece is cooled.

After the forming of the sheet coated with the said cross-linked composition and before curing this piece in order to pyrolyse the cross-linked polymer, a layer of powdery enamel frit can possibly be applied to at least one face of the said formed piece.

When a piece made from sheet, formed and covered with vitrified enamel, has been produced according to a method in accordance with the invention, a further layer of enamel can be applied to at least one of the two faces of this piece.

This can be carried out by applying (for example by electrostatic spraying with a gun) a layer of powdery enamel frit to at least one of the two faces of this piece, the piece covered with this enamel frit then being cured by raising its temperature to an appropriate temperature in order to obtain vitrification of this layer of enamel frit, after which the enamelled formed piece thus produced is cooled.

In the method of producing a piece formed from enamelled sheet, the forming of the sheet coated with the said cross-linked composition can be carried out by the usual methods of forming sheets, in particular therefore by drawing and/or plating and/or bending.

As regards the curing of the formed piece, it is important that the vitrification phase is separate from the pyrolysis phase. It is necessary, in fact, for the pyrolysis to be finished at a temperature below the glass transition temperature of the enamel frit. To that end, there can possibly be provided, in the temperature rise profile, a step (with a duration, for example, between 15 and 60 seconds) at a temperature (for example between 400° C. and 500° C.) at which the pyrolysis can be completed without the vitrification of the enamel frit starting. It is necessary to maintain an oxidising atmosphere in the curing oven, or the area of the curing oven which corresponds to this step, so as to facilitate the combustion of the carbonaceous matter.

As may be understood from the preceding description, the method according to the invention, for producing enamelled formed pieces, can exist in the form of many variants.

The whole of the method for producing a piece formed from enamelled sheet can possibly by carried out in one and the same place (the same workshop or the same factory, for example). In many cases, however, the successive steps of the method will be carried out in at least two distinct locations. Therefore, for example, the beginning of the method, that is to say the fabrication of the sheet (not formed) coated with the said cross-linked enamelling composition, can advantageously be carried out in or close to an iron and steel works, downstream of a rolling mill.

The sheets thus coated with the cross-linked composition can then be delivered (in the form of stacked plates or on reels) to a user (for example a manufacturer of household appliances or sanitary ware) who will complete the method from forming of the coated sheet up to obtaining of the piece made from metal sheet, formed and covered with the vitrified enamel.

With the technique in accordance with the invention, the enamel can be applied to the sheet in one or more layers.

In the majority of cases, the enamel will be applied in two layers, namely a “ground-coat” layer and a “cover-coat” layer. However, the enamel can possibly be applied in more than two layers, for example in three layers, namely first two “ground-coat” layers and finally a “cover-coat” layer.

The first layer (corresponding to the ground-coat enamel) will always be applied, in the form of a powdery composition according to the invention, to the flat sheet, and therefore before the forming.

A second layer of powdery composition according to the invention, which can correspond either to ground-coat enamel or to cover-coat enamel, can possibly be applied after the cross-linking curing of the first layer and before the forming. This second layer carried by the flat sheet must then, in its turn, be heated at a temperature and for a length of time making it possible to cross-link the thermosetting resin it contains.

After the forming of the sheet, a further layer of enamel (cover-coat enamel) can possibly be applied, before or after the curing for pyrolysis of the polymer and vitrification of the enamel of the layer (or layers) applied before the forming. It is important to note that any possible further layer applied after the forming consists solely of a layer of enamel frit. This is because, at this stage of the operations, there is no longer any reason to use a powdery composition according to the invention since the forming has already taken place.

Compared with the traditional enamelling method (enamelling of preformed pieces by means of enamel frit), the method according to the invention offers in particular the advantage that the sheets no longer have to be pre-treated at the premises of the user (the enameller). Application of the enamelling composition to a flat sheet is, moreover, much easier and quicker than application of enamel frit to an already formed piece. In a method according to the invention, application of the enamelling composition can be performed in a continuous operation, which makes it possible in particular to obtain a very good consistency of thickness of the layer of enamel.

The technique according to the invention also offers important advantages compared with a technique which necessitates the application, to a sheet, of a fluid composition comprising an enamel frit in suspension in a solution of polymer binder.

One obvious advantage of the technique according to the invention follows directly from the fact that the enamelling composition does not contain any solvent. In the known earlier technique in which a fluid composition containing organic solvents is used, large quantities of solvents (approximately 50 ml to 100 ml of solvent per m2 of coated surface) must be evaporated and incinerated.

Moreover, by using the powdery composition, a greater thickness of composition can be applied than by using fluid compositions. With a fluid composition, it is often necessary to apply two layers of composition—each followed by a cross-linking curing—in order to obtain a sufficient thickness of vitrified enamel after vitrification curing. With the powdery composition according to the invention, this result can be achieved by applying only a single layer of composition to the sheet.

The preparation of a powdery composition according to the invention is also easier than the preparation of a fluid enamelling composition and does not require the incorporation in the composition of dispersing agents, anti-settling agents or anti-foaming agents.

The enamel frit content of a powdery composition according to the invention can also be substantially higher than that of a fluid enamelling composition.

Other particular features and advantages of the invention will emerge from four variant embodiments described below by way of non-limiting examples.

### EXAMPLES 1, 2, 3 and 4

Products Used In These Four Examples

Sheet:

In each of the four examples, the sheet used is a cold-rolled steel sheet of the DC04EK type (European Standard EN 10209). It must be noted that the choice of this type of steel is in no way critical and that many other grades of steel can also be used (for example steels of the DC01EK or DC06EK type). In Examples 1, 2 and 3, this sheet has a thickness of 0.80 mm. In Example 4, the sheet has a thickness of 0.45 mm.

Resin:

In the four examples, the enamelling compositions contain as the thermosetting resin a powdered resin formulated as follows. The proportions of the constituents of this resin are given as a % by weight with respect to the total weight of the formulated resin:

| | |
|---|---|
| 90.88% | commercial polyester resin with carboxylic termination; |
| | Crylcoat 441 ® from the company UCB; |
| 6.84% | cross-linking agent: TGIC (triglycidyl isocyanurate): Araldite |
| | PT 810 ® from the company Ciba-Geigy; |
| 0.08% | catalyst: chosen from the phosphonium halide group; |
| 1.63% | spreading agent: liquid acrylic resin adsorbed on silica: |
| | Resiflow PV5 from the company Worlee; |
| 0.57% | degassing agent: benzoin |

Enamel Frit:

Ground-coat enamel frit: type GR from the company PEMCO.

This enamel frit is finely ground, so that 6 to 10% by volume has failed to pass after sieving with a 40 μm sieve (EN 10209).

Production of the Enamelled Formed Pieces

1. Preparation of the Steel Sheet Substrate

The steel sheet is subjected to alkaline degreasing (by means of a commercial solution of Parcolene 305C® from the company Chemetall), rinsing with demineralised water and amorphous phosphatising using iron (by means of a commercial solution of Bonderite 901® from the company Chemetall).

2. Preparation of the Enamelling Composition

The polyester resin is mixed dry with the additives (cross-linking agent, catalyst, spreading agent, degassing agent and, if applicable, lubricating agent) and with the enamel frit (in the form of fine powder) in the proportions indicated below (% by weight with respect to the total weight of the composition):

| Example | Resins total | Frit | Lubricating agent |
|---|---|---|---|
| 1 | 50 | 50 | 0 |
| 2 | 20 | 80 | 0 |
| 3 | 19 | 80 | 1 |
| 4 | 20 | 80 | 0 |

The lubricating agent which forms part of the composition according to Example 3 is a polyethylene wax.

This mixture is then transferred into a heated extruder in which it is first of all heated until fusion of the resin and the various additives (with the exception of course of the enamel frit). In the extruder, the composition is plasticated and mixed so as to obtain a perfect homogeneity of the components, and then extruded.

At the output of the extruder, the pasty product is rolled between two cooled cylinders, which makes it possible to obtain thin sheeting. This sheeting is transported by means of a cooled conveyor belt which lowers the temperature of the mixture and solidifies it. The solid material is then crushed and converted into chips. These chips are then finely ground in a grinder/screen and the homogenate is sieved.

The fine powder obtained has the following characteristics:

a deposit of 300 g/m2 makes it possible to obtain, for a composition containing 80% by weight enamel frit (Examples 2, 3 and 4) and after cross-linking curing, a thickness of approximately 250 μm,

this thickness of 250 μm is reduced to approximately 100 μm after complete pyrolysis of the organic matter and vitrification of the enamel frit.

3. Application of the Enamelling Composition to the Substrate

In Examples 1, 2 and 3, the enamelling composition is applied, in the laboratory, to one of the faces of the substrate, by means of an electrostatic gun of the “Corona”® type, until a coating of 300 g/m2 is obtained.

In Example 4, the enamelling composition is applied, on a semi-industrial line, to one of the faces of the substrate, by the continuous dusting method described in the document BE 9800367. Here also a coating of 300 g/m2 is obtained.

4. Cross-Linking of the Coating

In Examples 1, 2 and 3, the cross-linking curing is carried out in a hot-air oven raised to 330° C. during 100 seconds. The maximum temperature reached by the sheet during this cross-linking curing is 250° C.

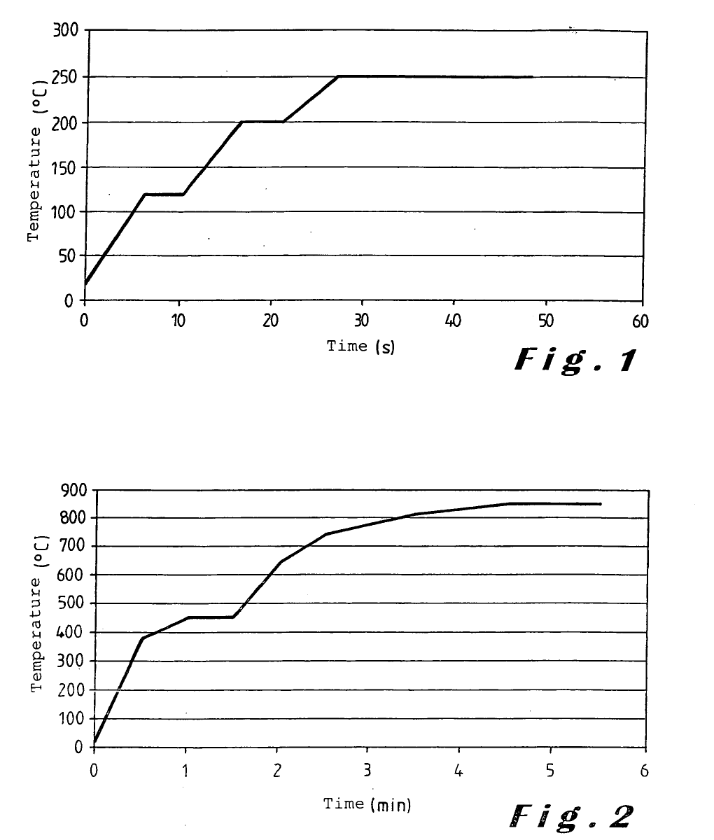

In Example 4, the cross-linking curing is carried out by passing the coated steel strip through a series of induction ovens according to the thermal profile illustrated in the accompanying FIG. 1. The maximum temperature reached by the sheet during this cross-linking curing is 250° C.; the holding time at this temperature is approximately 24 seconds.

5. Forming

In each of the four examples, flat samples are drawn or folded so as to be able to carry out the evaluation tests described later.

6. Pyrolysis Curing—Vitrification Curing

In each of the four examples, flat samples and formed samples, coated with the cross-linked composition, are passed into a tunnel furnace under ambient atmosphere. This tunnel furnace is provided with fume exhaust means. The thermal profile of this curing is shown in the graph of the accompanying FIG. 2.

The curing up to approximately 450° C. makes it possible to pyrolyse the organic constituents of the coating (the resin and other organic constituents). At this temperature of 450° C., a step with a duration of approximately 30 seconds is arranged in the temperature rise profile, so as to finish the pyrolysis before the temperature is increased again.

For vitrification of the enamel frit, the temperature increases up to approximately 850° C. This maximum temperature of 850° C. is maintained for approximately 1 minute.

Evaluation Tests

Evaluation tests were carried out on samples, at different stages in the preparation of the enamelled formed pieces. These tests are defined below and the results of the tests (for the samples of the four examples) are then given in a table.

1. Test carried out on the enamelling application composition after preparation: particle size distribution curve of the powder. The particle size distribution curve of the powder is measured on an apparatus of the Coulter® type. It is the value taken at the top of this curve which is included in the table of results.

2. Tests carried out on the sheet coated with cross-linked enamel composition:

2.1 Tribological properties of the coated surface:

The coefficient of friction on the coated surface is measured according to the so-called “progressive friction” method. This consists of measuring the force necessary to move, at a constant speed of 0.2 m/min, a sample held between a moving carriage and a tool, for increasing clamping forces, from 300 to 600 kg. The coefficient of friction is the ratio between the tractive force and the clamping force. It is generally stable between the values of clamping force used.

2.2 Resistance to cracking and detachment of the coating:

2.2.1 After folding (based on International Standard ISO 1519): a single bending at 180°, of conical form, is carried out; the minimum bending radius being 0 mm. The result obtained is dimensioned in “T”s which is the ratio of the bending radius to the thickness of the sheet. The “T” value makes it possible to define the limit for which cracking of the coating or loss of adherence in the folding area is observed.

2.2.2 After a 7 mm-deep drawing by means of an Erichsen test apparatus (in accordance with International Standard ISO 1520): the coating is examined with the naked eye in order to detect any cracks or losses of adherence.

2.2.3 After rapid deformation during the resistance to impact test (in accordance with standard ECCA T5 (European Coil Coating Association)): the maximum value of the energy of the impact is noted (in inch.pound converted into kg.cm) for which the following are not observed—a) cracks—b) loss of adherence.

2.3 Scratch resistance in accordance with the “Clemen” method (in accordance with International Standard ISO 1518): the minimum load is noted (in g) which allows the needle to penetrate through the coating and reach the metal.

2.4 Measurement of adhesion after the grid test (in accordance with International Standard ISO 2409): a series of perpendicular scratches are drawn, spaced 2 mm apart. An adhesive tape is then applied to the scratched area and then this tape is pulled off. Any coating detachment is dimensioned between the values 0 (the edges of the incisions are perfectly smooth; none of the squares of the grid has become detached) and 4 (the coating has become detached along the edges of the incisions in wide strips and/or some squares have become partly or totally detached. A surface area representing decidedly more than 35% up to approximately 65% is affected).

2.5 Solvent resistance: makes it possible to characterise the degree of cross-linking of the coating. A piece of cotton wool impregnated with methyl ethyl ketone is rubbed on the coated surface by imparting a series of 20 backwards and forwards movements. Any degradations of the coating subjected to this rubbing are observed.

3. Tests carried out on the enamelled sheet after vitrification curing:

3.1 Surface appearance: visual checking of the presence or absence of defects.

3.2 Presence of “fish scaling”: high-temperature heating of the steel coated with enamel in the presence of moisture causes an oxidation of the iron and the production of atomic hydrogen (H). This hydrogen penetrates the steel as a result of the increase in its solubility. The layer of vitrified enamel solidifies quickly, trapping this hydrogen in the steel. After return to normal temperature, owing to the drop in solubility, saturation of hydrogen (H) in the metal occurs. As the diffusivity of hydrogen remains high at ambient temperature, it accumulates in molecular form (H2) in all the “imperfections” in the steel, in particular at the enamel-steel interface. When the pressure of gas (H2) is locally too high, a semi-circular discontinuity occurs in the enamel similar to the mark of a fingernail in modelling clay, which is called “fish scaling”.

3.3 Adherence of the enamel to the substrate after the resistance to impact test (in accordance with European Standard EN 10209): rapid deformation of the enamelled sheet by a 1.5 kg mass falling from a height which is a function of the thickness of the sheet to be tested (minimum thickness 0.6 mm). The adherence of the enamel is then evaluated by comparing the appearance of the impact made on the tested enamelled sheet and the reference photographs. A grading is obtained in 5 levels, from “1” where the surface of the impact is entirely covered with enamel (excellent adherence) up to “5” where the surface of the impact is completely bare (steel), or the enamel/steel execution is clear (poor adherence). This test was not carried out on the samples of Example 4 for which the sheet has a thickness of 0.45 mm.

| | Example 1 | Example 2 | Example 3 | Example 4 |
|---|---|---|---|---|
| 1 - Tests on the | | | | |
| composition: | | | | |
| Maximum of the particle | 80 μm | 75 μm | 75 μm | 75 μm |
| size distribution curve | | | | |
| 2 - Tests on the non- | | | | |
| vitrified coated sheet | | | | |
| Coefficient of friction: | 0.18 | 0.20 | 0.14 | 0.20 |
| Conical folding: cracking limit | 4T | 6T | 6T | 10T |
| 7 mm Erichsen: | slight | slight | slight | slight |
| | cracking | cracking | cracking | cracking |
| Impact strength in kg · cm | | | | |
| (in lb · in) | | | | |
| without cracking: | 69 (60) | 69 (60) | 69 (60) | 46 (40) |
| without loss of adherence: | 138 (120) | 138 (120) | 138 (120) | 92 (80) |
| Clemen scratch | >5000 g | >5000 g | >5000 g | 4500 g |
| resistance: | | | | |
| Adherence after grid: | class 0 | class 0 | class 0 | class 1 |
| Solvent resistance: | no | no | no | no |
| | degradation | degradation | degradation | degradation |
| 3 - Tests on enamelled | | | | |
| sheet: | | | | |
| Surface appearance: | no defects | no defects | no defects | no defects |
| Fish scaling: | none | none | none | none |
| Impact strength: | class 1 | class 1 | class 1 | N/A |

1. Enamelling composition comprising an enamel frit and a thermosetting resin, this composition being characterised in that it consists of a powder in the form of a substance which contains no solvent for this resin.

2. Composition according to claim 1, characterised in that the thermosetting resin comprises:
one or more cross-linkable polymers,
one or more cross-linking agents able to cause the cross-linking of the cross-linkable polymer or polymers,
at least one catalyst able to catalyse the cross-linking reaction between the cross-linkable polymer or polymers and the cross-linking agent or agents.

3. Composition according to claim 2, characterised in that the cross-linkable polymer or polymers are chosen from amongst the cross-linkable polymers of the epoxy, polyester and acrylic type.

4. Composition according to any one of the preceding claims, characterised in that the thermosetting resin comprises at least one spreading agent.

5. Composition according to any one of the preceding claims, characterised in that the thermosetting resin comprises at least one degassing agent.

6. Composition according to any one of the preceding claims, characterised in that it comprises at least one lubricating agent.

7. Composition according to any one of the preceding claims, characterised in that it contains at least 50% by weight enamel frit, compared with the total weight of the composition.

8. Composition according to claim 7, characterised in that it contains at least 70% by weight enamel frit, with respect to the total weight of the composition.

9. Composition according to any one of the preceding claims, characterised in that the enamel frit has a particle size distribution such that less than 10% by volume has failed to pass after sieving with a 40 μm sieve.

10. Composition according to any one of the preceding claims, characterised in that the maximum of its particle size distribution curve measured on an apparatus of the Coulter® type is equal to or less than 100 μm.

11. Composition according to claim 10, characterised in that the maximum of its particle size distribution curve measured on an apparatus of the Coulter® type is equal to or less than 80 μm.

12. Method of manufacturing an enamelling composition according to any one of the preceding claims, characterised in that
enamel frit in powder form and thermosetting resin in powder or granular form are mixed dry,
this mixture is heated and plasticated at a temperature higher than the fusion temperature of the thermosetting resin but lower than the cross-linking temperature,
the mixture thus plasticated hot is then cooled below the glass transition temperature of the thermosetting resin,
the mixture thus cooled and solidified is then converted into powder.

13. Method according to claim 12, characterised in that the heating and plastication of the mixture at a temperature higher than the fusion temperature of the thermosetting resin are carried out in a heated extruder.

14. Method according to either one of claims 12 and 13, characterised in that the mixture heated and plasticated at a temperature higher than the fusion temperature of the thermosetting resin is rolled between cooled cylinders, the cooled sheeting thus obtained then being converted into powder by crushing and grinding.

15. Method of manufacturing a sheet of flat substance, coated with a composition containing an enamel frit and a thermosetting resin, characterised in that a layer of a powdery composition according to any one of claims 1 to 11 is applied to at least one of the two faces of the sheet, this layer then being heated at a temperature and for a length of time making it possible to cross-link the said thermosetting resin.

16. Method according to claim 15, characterised in that, after having applied a layer of the said powdery composition to at least one of the two faces of the sheet and after having caused the cross-linking of the thermosetting resin in this layer, a further layer of powdery composition according to any one of claims 1 to 11 is applied to at least one of the two faces of the said sheet, this further layer then being heated at a temperature and for a length of time making it possible to cross-link the thermosetting resin of this further layer.

17. Method according to either one of claims 15 and 16, characterised in that the said powdery composition is applied to the said sheet by electrostatic application.

18. Method according to any one of claims 15 to 17, characterised in that, before the application of a first layer of the said powdery composition to the sheet, this sheet is degreased.

19. Method according to any one of claims 15 to 18, characterised in that, before the application of a first layer of the said powdery composition to the sheet, this sheet is phosphatised.

20. Method according to any one of claims 15 to 19, characterised in that the heating of a layer of the said powdery composition applied to the sheet, in order to cross-link the thermosetting resin in this layer, is obtained by causing the said sheet to pass through one or more hot-air ovens.

21. Method according to any one of claims 15 to 20, characterised in that the heating of a layer of the said powdery composition applied to the sheet, in order to cross-link the thermosetting resin in this layer, is obtained by causing the said sheet to pass through one or more induction ovens.

22. Method of producing a piece formed from enamelled sheet, characterised in that
according to the method in accordance with any one of claims 15 to 21, a sheet made from flat substance is fabricated, coated with a composition containing an enamel frit and a thermosetting resin,
the sheet coated with the said cross-linked composition is formed in the form of the said piece to be produced,
the piece formed is cured under conditions adapted to obtain complete pyrolysis of the cross-linked polymer, the temperature being maintained below the vitrification temperature of the enamel frit contained in the composition, during this pyrolysis curing,
the curing of the piece is continued by increasing the temperature up to an appropriate temperature in order to obtain vitrification of the enamel,
the enamelled formed piece is cooled.

23. Method according to claim 22, characterised in that, after the forming of the sheet coated with the said cross-linked composition and before curing the formed piece in order to pyrolyse the cross-linked polymer, a layer of powdery enamel frit is applied to at least one face of the said formed piece.

24. Method according to either one of claims 22 and 23, characterised in that, after having cooled the enamelled formed piece,
a layer of powdery enamel frit is applied to at least one of the two faces of this formed piece,
the piece covered with this layer of powdery frit is cured by raising its temperature to an appropriate temperature for obtaining vitrification of this layer of enamel frit, and
the enamelled formed piece thus produced is cooled.
